(19) United States
(12) Patent Application Publication
(10) Pub. No.: US 2014/0258688 A1
(43) Pub. Date: Sep. 11, 2014

(54) BENCHMARK GENERATION USING INSTRUCTION EXECUTION INFORMATION

(71) Applicant: ADVANCED MICRO DEVICES, INC., Sunnyvale, CA (US)

(72) Inventors: Mauricio Breternitz, Austin, TX (US); Anton Chernoff, Littleton, MA (US); Keith A. Lowery, Garland, TX (US)

(73) Assignee: ADVANCED MICRO DEVICES, INC., Sunnyvale, CA (US)

(21) Appl. No.: 13/789,233

(22) Filed: Mar. 7, 2013

(51) Int. Cl. G06F 9/30

(52) U.S. Cl. CPC G06F 9/30079
USPC 712/220

(57) ABSTRACT

Methods and systems are provided for generating a benchmark representative of a reference process. One method involves obtaining execution information for a subset of the plurality of instructions of the reference process from a pipeline of a processing module during execution of those instructions by the processing module, determining performance characteristics quantifying the execution behavior of the reference process based on the execution information, and generating the benchmark process that mimics the quantified execution behavior of the reference process based on the performance characteristics.

### TECHNICAL FIELD

Embodiments of the subject matter described herein relate generally to computing systems, and more particularly, relate to generating benchmarks for evaluating performance of a computing device with respect to a process.

### BACKGROUND

The vast majority of electronic devices rely on one or more processing devices to execute instructions, code, software, or the like and support the desired functionality of the respective electronic device. As a result, performance of the electronic device is correlated with the performance of its processing device with respect to the particular instructions or other software required to support the functionality of the electronic device. Designers may make modifications to a processing device to improve performance, however, it is often difficult to obtain immediate feedback regarding how effective those modifications were at improving performance with respect to a particular software application. For example, a relatively large network-based software application (e.g., a social networking application, a database application, or the like) may include millions of instructions, and thus require an undesirably large amount of overhead to simulate the performance of such applications on a processing device. While benchmarks may be used to attempt to replicate the larger application for purposes of simulation, it is difficult to develop accurate benchmarks for applications that exhibit dynamic behavior at run-time (e.g., in response to real-time input to and/or output from the application).

### BRIEF SUMMARY

A method is provided for generating a benchmark representative of a reference process that includes a plurality of instructions. The method involves obtaining execution information for a subset of the plurality of instructions, determining performance characteristics for the reference process based on the execution information, and generating the benchmark based on the performance characteristics. The execution information for each respective instruction of the subset is obtained from a pipeline of a processing module during execution of that respective instruction by the processing module.

The above and other aspects may be carried out by an embodiment of a computing system. The computing system includes a pipeline arrangement, a profiling module, a workload analysis module, and a benchmark generation module. The pipeline arrangement executes a plurality of instructions corresponding to a reference process, and the profiling module is coupled to the pipeline arrangement to obtain execution information for a subset of the plurality of instructions from the pipeline arrangement. In this regard, the execution information for each respective instruction of the subset is obtained from the pipeline arrangement during execution of that respective instruction. The workload analysis module determines performance characteristics for the reference process based on the execution information, and the benchmark generation module generates a benchmark process representative of the reference process based on the performance characteristics.

In some embodiments, a computer-readable medium having computer-executable instructions stored thereon is provided. The computer-executable instructions are executable by a processing module to perform a reference process, obtain execution information for a subset of instructions of the reference process, determine performance characteristics for the reference process based on the execution information, and generate a benchmark process representative of the reference process based on the performance characteristics. The execution information for each respective instruction of the subset is obtained from a pipeline of a processing module during execution of that respective instruction by the processing module.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of a computing system in accordance with one or more embodiments; and

FIG. 2 is a flow diagram of an exemplary benchmarking process suitable for implementation by the computing system of FIG. 1, in accordance with one or more embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Embodiments of the subject matter described herein relate to generating a benchmark process that is representative of a reference process. A processing module performs or otherwise executes the reference process by executing the machine language instructions corresponding to the reference process. During execution of the reference process by the processing module, execution information for a subset of the reference process instructions is obtained from the processing module. In this regard, information detailing execution of each respective instruction of the subset is obtained from a respective stage of an instruction pipeline of the processing module while that instruction resides in that stage of the instruction pipeline during execution of that instruction. In this manner, for each respective instruction of the subset, information describing or otherwise detailing execution of that instruction by a respective stage of the instruction pipeline is obtained in parallel to that instruction being executed by that respective pipeline. As a result, the reference process 150 may be receiving or otherwise responding to real-time inputs and/or outputs during execution.

As described in greater detail below, the aggregate execution information for the subset is then utilized to determine workload performance characteristics that quantify or otherwise describe various behavioral aspects of the reference process during execution, such as, for example, the branching behavior and/or control flow, the cache behavior, the memory behavior, the dependency behavior, and the like. Using the workload performance characteristics, a synthetic benchmark process is generated by constructing a sequence of instructions (or code) configured to mimic or otherwise exhibit the execution behavior of the reference process described by the workload performance characteristics, but with a reduced number of instructions relative to the reference process. Accordingly, the synthetic benchmark process may be utilized to measure, asses, estimate, or otherwise simulate the performance of a processing module, an instruction pipeline, or another computer architecture with respect to the dynamic real-time behavior reference process without the overhead associated with executing (or alternatively, simulating execution of) the full set of instructions for the reference process by that processing module, instruction pipeline, or computer architecture.

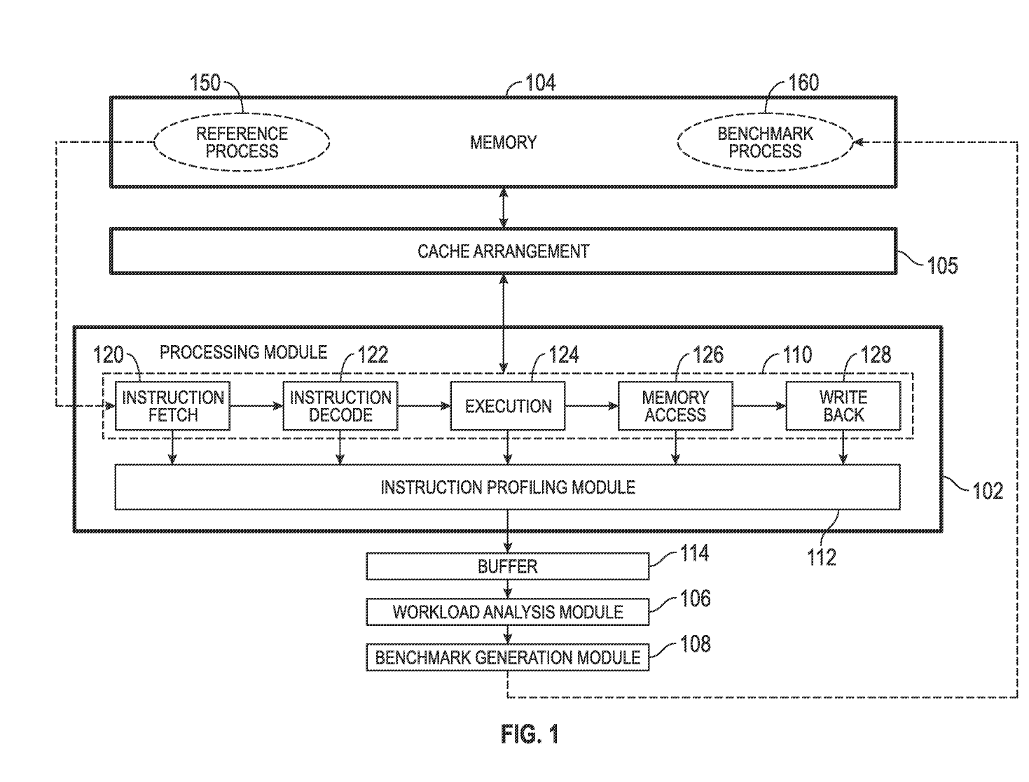

Turning now to FIG. 1, an exemplary computing system 100 includes, without limitation, a processing module 102, a data storage element (or memory) 104, a caching arrangement 105, a workload analysis module 106, and a benchmark generation module 108. The processing module 102 includes an instruction pipeline arrangement 110 configured to execute a set of machine language instructions corresponding to a reference process 150 stored or otherwise maintained in memory 104. As described in greater detail below, the processing module 102 also includes an instruction profiling module 112 that is coupled to the individual stages of the pipeline 110 and samples the individual stages of the pipeline 110 on a periodic basis to obtain execution information for a subset of the instructions of the reference process 150 as those instructions of the subset propagate through the pipeline 110. The workload analysis module 106 is communicatively coupled to the instruction profiling module 112 to obtain the execution information for the instruction subset and analyzes the execution information to determine workload performance characteristics for the reference process 150. The benchmark generation module 108 is communicatively coupled to the workload analysis module 106 to obtain the workload performance characteristics, generate a synthetic benchmark process 160 representative of the reference process 150 based on the workload performance characteristics, and store or otherwise maintain the code for that synthetic benchmark process 160 in the memory 104 or another suitable data storage element. As described in greater detail below, the synthetic benchmark process 160 exhibits execution behavior similar to that of the reference process 150 but includes a fewer number of instructions, thereby allowing the synthetic benchmark process 160 to be subsequently utilized to assess performance of the processing module 102 (or some other processing module, instruction pipeline, or computer architecture) with respect to the reference process 150 without the overhead associated with executing (or alternatively, simulating execution of) the reference process 150 in its entirety.

Depending on the embodiment, the processing module 102 may be realized as a central processing unit (CPU), a processing core, a processor, a processing device, a graphics processing unit (GPU) or graphics processing core, or another suitable processing system that includes a pipeline 110 capable of executing the machine language instructions for the reference process 150 in conjunction with the benchmarking process described herein. In the illustrated embodiment of FIG. 1, the pipeline 110 includes an instruction fetch stage 120, an instruction decode stage 122, an execution stage 124, a memory access stage 126, and a write back stage 128. The instruction fetch stage 120 generally represents the hardware components configured to retrieve or otherwise obtain an individual instruction of the reference process 150 from the memory 104 (or an instruction cache) and provide the instruction to the instruction decode stage 122 before obtaining a subsequent instruction of the reference process 150 from the memory 104. The instruction decode stage 122 represents the hardware components configured to decode an instruction received from the instruction fetch stage 120 and provide the operation corresponding to the decoded instruction to the execution stage 124. The execution stage 124 generally represents the hardware components (e.g., an arithmetic logic unit or the like) configured to perform the mathematical and/or logical operation corresponding to the decoded instruction. The result of the execution stage 124 is provided to the memory access stage 126, which represents the hardware configured to transfer data to/from the memory 104 and/or the caching arrangement 105 in accordance with the operation specified by the instruction. Depending on the type of operation specified by a particular instruction, the write back stage 128 writes the result of the execution stage 124 or the result of the memory access stage 126 into the appropriate register (not illustrated in FIG. 1) of the processing module 102.

The instruction profiling module 112 generally represents the components of the processing module 102 that are capable of obtaining execution information for individual instructions that propagate through the pipeline 110 in parallel to those instructions being executed by the pipeline 110. In exemplary embodiments, the instruction profiling module 112 periodically selects an instruction for sampling based on a configurable sampling period and then samples each stage of the pipeline 110 while that selected instruction is being executed by that stage of the pipeline 110 to obtain the execution information for that selected instruction as it propagates through the pipeline 110. In this regard, the instruction profiling module 112 samples a stage of the pipeline 110 while a selected instruction is being executed by that stage of the pipeline 110 by copying, to the buffer 114, the bits of data maintained by the pipeline register that immediately follows that stage of the pipeline 110 on the next clock cycle after the selected instruction is provided to that stage of the pipeline 110 along with an indication of which stage of the pipeline 110 the copied bits of data were obtained from. Accordingly, a sample includes the bits of data maintained by a pipeline register at a particular instance in time during execution of the selected instruction.

By way of example, the instruction profiling module 112 may be configured to sample every N number (e.g., 1,000) of instructions executed by the processing module 102, wherein the instruction profiling module 112 implements a counter that is synchronized with the pipeline 110 to detect or otherwise identify when every N^{th} (e.g., 1,000^{th}) instruction will begin execution by the pipeline 110. In this regard, for a reference process 150 having M number (e.g., 100,000) of instructions and a sampling period of N (e.g., 1,000) instructions, the instruction profiling module 112 will obtain execution information for MIN number (e.g., 100,000/1000=100) of instructions of the reference process 150. Depending on the embodiment, the sampling period may be adjusted to increase or decrease the percentage of instructions of the reference process 150 that are sampled (e.g., the ratio of the sampling period to the number of instructions in the reference process 150) to achieve a desired level of accuracy and/or similarity for the synthetic benchmark process 160 with respect to the reference process 150. That said, by virtue of maintaining a relatively low rate of sampling (e.g., by sampling less than about 5% to 10% of the instructions of the reference process 150), the instruction profiling module 112 does not appreciably impact the execution of the reference process 150 by the processing module 102 by virtue of the relatively low amount of sampling overhead, so that the instruction profiling module 112 may obtain the execution information from the pipeline 110 while the processing module 102 and/or reference process 150 are “online” or “live.” In this regard, while the reference process 150 is being sampled by the instruction profiling module 112, the reference process 150 may be concurrently receiving real-time inputs and/or outputs that dynamically affect the control flow and/or execution behavior of the reference process 150.

After identifying or otherwise selecting an instruction for sampling, the instruction profiling module 112 accesses the instruction fetch stage 120 while that selected instruction resides in the instruction fetch stage 120 to obtain fetch stage execution information for the selected instruction by copying the bits of data maintained by the pipeline register that immediately follows the instruction fetch stage 120 (i.e., the pipeline register between the instruction fetch stage 120 and the instruction decode stage 122) to the buffer 114. The copied bits of data of fetch stage execution information may include or otherwise indicate the fetch address, whether the fetch completed or aborted, whether the fetch generated a miss in an instruction cache, whether the fetch generated a miss in a translation lookaside buffer (TLB), the page size of address translation, and/or the fetch latency (e.g., a number of cycles from when the fetch was initiated to when the fetch completed or aborted). Thereafter, once the selected instruction is passed to the instruction decode stage 122, the instruction profiling module 112 accesses the instruction decode stage 122 while the selected instruction is in the instruction decode stage 122 of the pipeline 110 to obtain decode stage execution information for the selected instruction (i.e., by copying the bits of data maintained by the pipeline register between the instruction decode stage 122 and the execution stage 124 to the buffer 114). The copied bits of data of decode stage execution information may include or otherwise indicate the number of instructions that were decoded, the number of micro-operations produced for the decoded instructions, whether the micro-operations were invoked, whether a particular instruction uses the result of a preceding instruction, and the like.

Continuing through the illustrated instruction pipeline 110, once the selected instruction is passed to the execution stage 124, the instruction profiling module 112 accesses the execution stage 124 while the selected instruction is in the execution stage 124 of the pipeline 110 to obtain execution stage execution information for the selected instruction, such as, for example, the instruction address for the operation being executed and the type of operation being executed (e.g., branch, load, store, or the like). For mathematical or logical operations, the instruction profiling module 112 may obtain the operands of the operation and indication of whether the operation corresponds to a floating point instruction or an integer instruction. If the operation is a branch, the instruction profiling module 112 may obtain the branching behavior of the operation, such as, for example, whether a branch was mispredicted, whether a branch was taken, whether a branch was a return, or whether a return was mispredicted, or the like. Once the selected instruction is passed to the memory access stage 126, the instruction profiling module 112 accesses the memory access stage 126 while the selected instruction is in the memory access stage 126 of the pipeline 110 to obtain memory access stage execution information for the selected instruction when the operation is a memory operation (e.g., load, store, move, etc.), such as, for example, one or more of the following: a memory address being accessed, whether the operation generated a hit or miss in the caching arrangement 105, the respective levels of the caching arrangement 105 that the hit or miss occurred in, the latency (or number of cycles) required to obtain requested data from the addressed location in memory 104 in the case of a miss, the virtual and/or physical address of the requested memory location, whether the memory address is aligned, the memory access size, and the like. Thereafter, once the selected instruction is passed to the write back stage 128, the instruction profiling module 112 accesses the write back stage 128 while the selected instruction is in the write back stage 128 of the pipeline 110 to obtain write back stage execution information for the selected instruction, such as, for example, whether a branch will be taken or not, total execution latency for the instruction (e.g., how many cycles the instruction took to execute), or the like.

As described above, in exemplary embodiments, the instruction profiling module 112 stores or otherwise maintains the sampled execution information (i.e., the bits of data copied from the pipeline registers) for a selected instruction in a buffer 114. The size of the buffer 114 is chosen to store or otherwise maintain the sampled execution information for each instruction of the subset of instructions of the reference process 150 that were sampled by the instruction profiling module 112. It should be noted that although FIG. 1 depicts the buffer 114 as being separate from the memory 104, in practice, the buffer 114 may be implemented as part of the memory 104 (e.g., as a logical partition within the memory 104).

Still referring to FIG. 1, the memory 104 represents any non-transitory short or long term data storage element or any other computer-readable media capable of storing computer-executable programming instructions corresponding to the reference process 150 for execution by the processing module 102. The memory 104 may be realized as any sort of hard disk, random access memory (RAM), read only memory (ROM), flash memory, magnetic or optical mass storage, or the like. The caching arrangement 105 generally represents combination of one or more data storage elements (“caches”) that are smaller in size than the memory 104 and have a faster access time (or lower latency) relative to the memory 104. Typically, the caches store blocks of data previously retrieved from the memory 104, and the caches are arranged in a hierarchical manner, so that if desired data is not found in a cache in the lowest level of the caching arrangement 105 (e.g., a cache miss), a cache in the next higher level of the hierarchy is checked for the desired data, and so on, before accessing the memory 104 for the data. Various caching techniques and structures are well known, and accordingly, will not be described herein. It should be noted that although FIG. 1 depicts the caching arrangement 105 as being separate from the processing module 102, in practice, the entire caching arrangement 105 or a portion thereof may be implemented as part of the processing module 102 (e.g., on the same chip or die as the instruction pipeline arrangement 110), and the subject matter described herein is not limited to any particular type of caching arrangement 105.

As described above, the workload analysis module 106 generally represents the component of the computing system 100 that is configured to access the buffer 114 to obtain the sampled execution information for the subset of instructions of the reference process 150 that are sampled by the instruction profiling module 112, and based on the sampled execution information, calculate or otherwise determine workload performance characteristics for the reference process 150. As used herein, a workload performance characteristic should be understood as referring to a parameter or statistic that quantifies or otherwise describes an aspect of the execution behavior of the reference process 150, such as, for example, a number of basic blocks in the reference process 150, a number of instructions in a basic block (e.g., the size of a basic block), a composition of a basic block (e.g., a number of instructions of a particular type within a basic block, such as a number of floating point instructions, a number of integer instructions, or the like), a distance between dependencies within a basic block, the branching behavior of a branch instruction in a basic block (e.g., the probability or frequency of branching in a particular direction), the cache behavior for a basic block (e.g., the probability or frequency of a cache hit or miss), a stride distance (e.g., a difference between memory addresses for successive memory accesses in a basic block), and the like. The benchmark generation module 108 represents the component of the computing system 100 that is configured to obtain the workload performance characteristics from the workload analysis module 106 and generate the synthetic benchmark process 160 representative of the reference process 150 based on the workload performance characteristics.

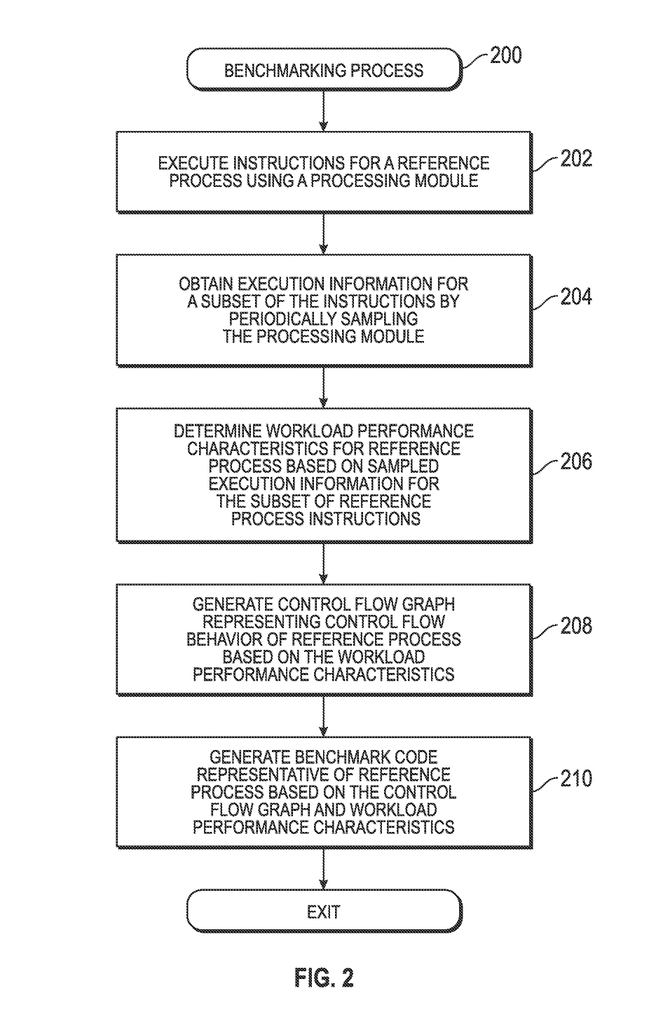

As described in greater detail below in the context of FIG. 2, the benchmark generation module 108 may construct or otherwise generate a control flow graph representative of the reference process 150 using the workload performance characteristics (e.g., the number of basic blocks, number of instructions per each basic block, the branching behavior among branching instructions with each basic block, etc.). Using the control flow graph and the remaining workload performance characteristics, the benchmark generation module 108 generates a sequence of instructions (or code) that emulates or otherwise mimics the execution behavior of the reference process 150. For example, using the stride distance for a particular basic block of the reference process 150, the benchmark generation module 108 may generate code that results in a basic block having a difference in memory addresses of successive memory accesses within that basic block that is substantially equal to the stride distance, and additionally, the code for that basic block may be configured to have the same composition (e.g., relative percentages of different types of instructions), cache behavior and/or branching behavior as the corresponding basic block of the reference process 150. In this manner, the execution behavior for the code of the synthetic benchmark process 160 mimics the execution behavior of the reference process 150, however, the total number of instructions in the synthetic benchmark process 160 may be less than the number of instructions in the reference process 150. The benchmark generation module 108 stores or otherwise maintains the code for the synthetic benchmark process 160 in the memory 104 or another computer-readable medium as a file (e.g., a binary file or the like) that may be subsequently executed by a processing module, instruction pipeline, or another computer architecture to assess the likely performance of that processing module, instruction pipeline, or computer architecture with respect to the dynamic real-time behavior of the reference process 150 without the overhead associated with executing the reference process 150 in its entirety, or alternatively, the synthetic benchmark process 160 may be utilized to simulate execution of the reference process 150 by that processing module, instruction pipeline, or computer architecture without the overhead associated with simulating the reference process 150 and the potential real-time inputs and/or outputs to the reference process 150.

It should be appreciated that FIG. 1 depicts a simplified representation of the computing system 100 for purposes of explanation and ease of description, and FIG. 1 is not intended to limit the subject matter described herein in any way. For example, in practice, the processing module 102 may include multiple instances of the pipeline arrangement 110 for greater parallelism. Additionally, the computing system 100 may include additional elements configured to support the operation of the computing system 100 described herein.

FIG. 2 depicts an exemplary benchmarking process 200 suitable for implementation by the computing system 100 of FIG. 1 to generate a synthetic benchmark process 160 representative of a reference process 150. The various tasks performed in connection with the benchmarking process 200 may be performed by hardware, firmware, software, or any combination thereof. For illustrative purposes, the following description of the benchmarking process 200 may refer to elements mentioned above in connection with FIG. 1, such as, for example, the processing module 102, the pipeline arrangement 110, the instruction profiling module 112, the workload analysis module 106, and/or the benchmark generation module 108. It should be appreciated that the benchmarking process 200 may include any number of additional or alternative tasks, the tasks need not be performed in the illustrated order and/or the tasks may be performed concurrently, and/or the benchmarking process 200 may be incorporated into a more comprehensive procedure or process having additional functionality not described in detail herein. Moreover, one or more of the tasks shown and described in the context of FIG. 2 could be omitted from a practical embodiment of the benchmarking process 200 as long as the intended overall functionality remains intact.

Referring now to FIGS. 1-2, the benchmarking process 200 begins at block 202 with a processing module performing a reference process by executing the machine language instructions corresponding to the reference process and periodically sampling the processing module to obtain execution information for a subset of those reference process instructions at block 204. As described above, the instruction pipeline arrangement 110 fetches or otherwise obtains instructions for the reference process 150 from the memory 104 and passes or otherwise provides those instructions to successive stages of the instruction pipeline arrangement 110 to carry out the operations dictated by the instructions, and thereby implement the reference process 150 in accordance with those operations. While the reference process 150 is being executed by the instruction pipeline 110, the instruction profiling module 112 samples the instruction pipeline 110 in accordance with a predefined sampling period to obtain execution information for individual instructions of the reference process 150 in parallel with those instructions being executed by the stages of the instruction pipeline 110. For an individual instruction of the reference process 150 selected to be sampled, the instruction profiling module 112 obtains, from a respective stage of the instruction pipeline arrangement 110, information detailing the execution of the selected instruction by that respective stage during execution of that instruction by that respective stage or while that selected instruction otherwise resides in that respective stage. Once the selected instruction is passed to a successive stage of the instruction pipeline arrangement 110, the instruction profiling module 112 similarly obtains, from that successive stage, information detailing the execution of the selected instruction by that stage during execution of that instruction by that stage, and so on. In this manner, for an instruction selected for sampling, the instruction profiling module 112 effectively tracks that instruction through the stages of the instruction pipeline arrangement 110 to obtain execution information for that instruction from each stage of the instruction pipeline arrangement 110. The instruction profiling module 112 stores, writes, or otherwise provides, to the buffer 114, the sampled execution information for the sampled instruction. In this manner, the buffer 114 maintains the sampled execution information for the subset of instructions of the reference process 150 that were sampled.

After obtaining execution information for a subset of instructions of the reference process, the benchmarking process 200 continues by determining workload performance characteristics for the reference process based on the sampled execution information for that subset of instructions at block 206. In this regard, the workload analysis module 106 analyzes the sampled execution information across all of the sampled instructions to calculate or otherwise determine parameters or statistics that quantify or otherwise describe aspects of the execution behavior of the reference process 150. For example, as described above, the workload analysis module 106 may analyze the sampled execution information maintained in the buffer 114 for all of the sampled instructions of the reference process 150 and determine, based on the sampled execution information, a classification or distribution of basic blocks in the reference process 150 based on the number of instructions per basic block and the branching behavior among the different basic blocks (e.g., the probability or frequency of branching in a particular direction from one basic block to another basic block). The probability or frequency of branching in a particular direction from a basic block may be calculated or otherwise determined based on sampled information obtained from execution stage, for example, by counting the number of times a branch was taken and the number of times the branch was executed. Then, for each of those differently categorized basic blocks, the workload analysis module 106 may determine a relative composition of that respective basic block (e.g., a percentage of instructions in that basic block that are integer instructions, a percentage of instructions in that basic block that are floating point instructions, a percentage of instructions in that basic block that access memory, etc.), for example, using the information identifying the instruction type that was obtained from the execution stage 124. The workload analysis module 106 may also determine, for each basic block, an average distance between dependencies of instructions in that basic block based on sampled information obtained from the decode stage, for example, by identifying the instruction addresses which use the result of a preceding instruction and averaging the differences between instruction addresses of those dependent instructions.

Additionally, for each basic block, the workload analysis module 106 may determine the cache behavior for the memory access instructions in that basic block (e.g., the frequency of cache hits and/or misses along with the respective levels of caches that were hit or missed) along with a stride distance for the memory access instructions in that basic block. For example, using the information obtained from the execution stage 124 identifying cache hits or misses along with the levels of the caching arrangement 105 where the hits or misses occurred, the workload analysis module 106 may determine the frequency of cache hits and/or misses along with the respective levels of caches that were hit or missed for each memory access instruction in a basic block. The stride distance may be calculated by determining the greatest common divisor between differences in the addressed locations for different sampled instances of a memory access instruction in a basic block using the information identifying the target (or destination) address in memory 104 that was obtained from the memory access stage 126. For example, if the difference between the sampled addressed location for a first instance of the memory access instruction and the sampled addressed location for a second instance of the memory access instruction is 64 bytes and the difference between the sampled addressed location for the first instance of the memory access instruction and the sampled addressed location for a third instance of the memory access instruction is 160 bytes, the stride distance may be determined to be 32 bytes, which is the greatest common divisor for 64 and 160. In this manner, the workload performance characteristics quantify the detailed execution behavior of the different basic blocks of the reference process 150 along with the interrelationships between basic blocks of the reference process 150.

After determining the workload performance characteristics for the reference process, the benchmarking process 200 continues at block 208 by generating a control flow graph representative of the reference process based on the workload performance characteristics. In this regard, the benchmark generation module 108 receives the workload performance characteristics from the workload analysis module 106, and using the differently classified basic blocks and the branching behavior to/from those differently classified basic blocks, the benchmark generation module 108 generates the control flow graph representative of the reference process 150. For example, the benchmark generation module 108 may construct the control flow graph by using the differently classified basic blocks as nodes and using the branching behavior to define the edges of the control flow graph.

After constructing the control flow graph, the benchmarking process 200 continues by generating the code for the synthetic benchmark process based on workload performance characteristics using the control flow graph at block 210. In exemplary embodiments, the benchmark generation module 108 generates the code of the synthetic benchmark process 160 using the control flow graph and the additional workload performance characteristics for the basic blocks of the control flow graph. In this regard, for each basic block, the benchmark generation module 108 may generate a sequence of instructions that is likely to exhibit the execution behavior quantified by the workload performance characteristics for that basic block. For example, sequence of instructions may be created that has substantially the same relative composition of instructions as its corresponding basic block of the reference process 150 (e.g., the same percentage of integer instructions relative to the percentages of floating point instructions, memory access instructions, and the like), a distance between dependent instructions equal to the average distance between dependencies for its corresponding basic block of the reference process 150 and substantially the same stride distance for any successive memory access instructions in that basic block. Additionally, the generated instructions may be configured to exhibit substantially the same cache behavior (i.e., the same frequency of hits or misses in the same levels of the caching arrangement 105) or otherwise emulate the cache behavior of the corresponding basic block of the reference process 150. At the same time, the total number of instructions in the sequence may be less than the actual number of instructions in the reference process 150 that make up that basic block. For example, the sequence of instructions generated by the benchmark generation module 108 for a particular basic block may be chosen to be the minimum number of instructions required to adequately emulate the behavior of the corresponding basic block in the reference process 150 (e.g., the minimum number of instructions needed to approximate the relative composition, cache behavior and branching behavior within a desired level of accuracy).

Once the benchmark generation module 108 generates code (or instruction sequences) corresponding to each of the basic blocks of the control flow graph, the benchmark generation module 108 uses the branching behavior between blocks to link or otherwise join the instruction sequences for the basic blocks to provide the synthetic benchmark process 160 having a control flow behavior that matches the control flow of the reference process 150 and workload performance characteristics substantially the same as those determined based on the sampled execution information for the reference process 150. Thus, the execution behavior of (and the corresponding control flow graph of) the synthetic benchmark process 160 mimics that of the dynamic real-time execution behavior of the reference process 150 while using fewer total number of instructions. In exemplary embodiments, the benchmark generation module 108 creates a binary file of the code for the synthetic benchmark process 160, which is then stored or otherwise maintained in the memory 104 or another suitable computer-readable medium. Thereafter, the binary file may be subsequently executed by another processing module or computing system (or alternatively, the same processing module 102 and/or computing system 100) to measure or otherwise assess the likely performance of that processing module and/or computing system with respect to the dynamic real-time behavior of the reference process 150 without the overhead associated with having to execute the reference process 150. Similarly, the synthetic benchmark process 160 may be utilized to simulate the performance of a processing module and/or architecture in development to better assess its likely performance with respect to the dynamic real-time behavior of the reference process 150 without overhead of fabricating that processing module and/or architecture and then executing the reference process 150 on the fabricated processing module and/or architecture, only to discover that the performance of the processing module and/or architecture is not satisfactory for the dynamic real-time execution of the reference process 150.

For the sake of brevity, conventional techniques related to processing architectures, pipelining and/or instruction parallelism, caching, memories, control flow graphs, benchmark generation, and other functional aspects of the subject matter may not be described in detail herein. In addition, certain terminology may also be used herein for the purpose of reference only, and thus are not intended to be limiting. For example, the terms “first,” “second,” and other such numerical terms referring to structures do not imply a sequence or order unless clearly indicated by the context.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, the subject matter may include code segments or instructions that perform the various tasks described herein. The program or code segments can be stored in a processor-readable medium. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like.

While at least one exemplary embodiment has been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof. Accordingly, details of the exemplary embodiments or other limitations described above should not be read into the claims absent a clear intention to the contrary.

What is claimed is:

1. A method of generating a benchmark representative of a reference process comprising a plurality of instructions, the method comprising:
obtaining execution information for a subset of the plurality of instructions, the execution information for each respective instruction of the subset being obtained from a pipeline of a processing module during execution of that respective instruction by the processing module;
determining performance characteristics for the reference process based on the execution information; and
generating the benchmark based on the performance characteristics.

2. The method of claim 1, wherein determining the performance characteristics comprises quantifying an execution behavior of the reference process based on the execution information.

3. The method of claim 2, wherein generating the benchmark comprises generating a sequence of instructions configured to mimic the quantified execution behavior.

4. The method of claim 1, wherein generating the benchmark comprises generating a sequence of instructions having an execution behavior that mimics the reference process.

5. The method of claim 1, wherein obtaining the execution information comprises periodically sampling the pipeline of the processing module.

6. The method of claim 1, wherein obtaining the execution information comprises, for each instruction of the subset, obtaining, from each respective stage of the pipeline, information detailing execution of that respective instruction by that respective stage of the pipeline.

7. The method of claim 6, wherein determining the performance characteristics comprises quantifying an execution behavior of the reference process based on the execution information.

8. The method of claim 7, wherein generating the benchmark comprises generating a sequence of instructions configured to mimic the execution behavior of the reference process quantified based on the performance characteristics.

9. The method of claim 1, wherein:
the execution information comprises memory addresses being accessed by instructions of the subset;
determining the performance characteristics comprises determining a stride distance between memory accesses based on the memory addresses; and
generating the benchmark comprises generating code having a distance between successive memory accesses equal to the stride distance.

10. The method of claim 1, wherein:
determining the performance characteristics comprises determining an average distance between dependencies in a basic block of the reference process based on the execution information; and
generating the benchmark comprises generating a sequence of instructions for a basic block of the benchmark having a distance between dependencies corresponding to the average distance.

11. The method of claim 1, wherein:
determining the performance characteristics comprises determining a relative composition of a basic block of the reference process based on the execution information; and
generating the benchmark comprises generating code for a basic block of the benchmark having a composition corresponding to the relative composition of the basic block of the reference process.

12. The method of claim 1, wherein:
determining the performance characteristics comprises determining an average branching behavior of a basic block of the reference process based on the execution information; and
generating the benchmark comprises generating a sequence of instructions for a basic block of the benchmark configured to exhibit the average branching behavior.

13. A computing system comprising:
a pipeline arrangement to execute a plurality of instructions corresponding to a reference process;
a profiling module coupled to the pipeline arrangement to obtain execution information for a subset of the plurality of instructions from the pipeline arrangement, the execution information for each respective instruction of the subset being obtained from the pipeline arrangement during execution of that respective instruction;
a workload analysis module to determine performance characteristics for the reference process based on the execution information; and
a benchmark generation module to generate a benchmark process representative of the reference process based on the performance characteristics.

14. The computing system of claim 13, wherein:
the pipeline arrangement comprises a plurality of stages; and
the profiling module is coupled to the plurality of stages to obtain, for each instruction of the subset, information detailing execution of that respective instruction by a respective stage of the plurality of stages.

15. The computing system of claim 13, wherein:
the pipeline arrangement comprises a plurality of stages; and
the profiling module is coupled to the plurality of stages to track execution of each instruction of the subset throughout the plurality of stages to obtain information detailing execution of that respective instruction of the subset by each stage of the plurality of stages.

16. The computing system of claim 13, wherein the profiling module is configured to periodically sample the pipeline arrangement to obtain the execution information.

17. The computing system of claim 13, further comprising a memory coupled to the pipeline arrangement, the memory maintaining the plurality of instructions for the reference process, wherein the benchmark generation module is configured to store the benchmark process in the memory.

18. A computer-readable medium having computer-executable instructions stored thereon executable by a processing module to:
perform a reference process comprising a plurality of instructions;
obtain execution information for a subset of the plurality of instructions, the execution information for each respective instruction of the subset being obtained from a pipeline of the processing module during execution of that respective instruction by the processing module;
determine performance characteristics for the reference process based on the execution information; and
generate a benchmark process representative of the reference process based on the performance characteristics.

19. The computer-readable medium of claim 18, wherein the computer-executable instructions stored thereon are executable by the processing module to obtain the execution information by periodically sampling stages of the pipeline.

20. The computer-readable medium of claim 18, the execution information comprising information detailing execution of each respective instruction of the subset by each respective stage of the pipeline, wherein the computer-executable instructions stored thereon are executable by the processing module to:
quantify an execution behavior of the reference process based on the execution information; and
generate a sequence of instructions configured to mimic the quantified execution behavior.
